(19) United States
(12) Patent Application Publication
(10) Pub. No.: US 2012/0234667 A1
(43) Pub. Date: Sep. 20, 2012

(54) Desalination Apparatus, A Module For Use In A Desalination Aparatus, And A Method of Desalinating A Saline Water Source

(76) Inventor: Barry Douglas Coots, Greater Manchester (DE)

(21) Appl. No.: 13/512,819

(22) PCT Filed: Dec. 1, 2010
(86) PCT No.: PCT/GB2010/051999

§ 371 Date: May 30, 2012

(30) Foreign Application Priority Data
Dec. 1, 2009 (GB) 0921042.8

(51) Int. Cl. B01D 3/02; C02F 1/14; C02F 1/04

(52) U.S. Cl. 203/10; 202/185.1; 202/173; 202/185.2; 202/177

(57) ABSTRACT

A desalination apparatus (100) comprises a series of modules (110) which may be mounted on supports (150). Seawater (12) flows through base units (130) along a channel (131) by gravity and is heated by a heating unit (140) such as solar lenses (141) to produce water vapour. A chimney (160) induces an airflow AF laterally across the channel (131) and substantially perpendicularly to the water flow WF. The airflow AF draws the water vapour to a condenser (70) that collects fresh water. The condenser (170) may be mounted within the chimney (160) and may use cold seawater as a coolant.

### BACKGROUND

1. Technical Field

The present invention relates generally to the field of desalination. More particularly, the present invention relates to a desalination apparatus, a module for use in a desalination apparatus, and to a method of desalinating a saline water source.

2. Description of Related Art

There is a worldwide need for effective sources of fresh water, such as for drinking or for irrigation. Arid areas expend a great deal of money and energy providing fresh water for their populations. Sometimes, water is pumped great distances from a suitable source to reach the places where the water is needed. Hence, it is desirable to significantly reduce the energy cost and monetary cost of providing fresh water. Generating electricity to pump water has a high carbon cost, and thus a reduction in electric energy consumption would be highly beneficial.

A desalination plant produces fresh water by desalinating a saline water source. Several thousand desalination plants are currently in use around the world, which remove salts and minerals from a saline water source such as sea water to provide fresh water in useful quantities for a local population. Generally, a desalination plant uses a heat source to boil saline water, and then recover fresh water by condensing the water vapour. However, many of these desalination plants rely on coal, oil, gas or nuclear power either as a direct heat source or for generating electricity that is then used by the desalination plant. Generally, it is desired to reduce this dependency on non-renewable energy sources.

It is known to use solar energy in a desalination plant. As one example, US-A-2008/083604 (Al-Garni et al) mentions a self-sustaining wind-solar desalination farm and park system which includes solar powered desalination units. Each unit has a trough to hold sea water, and sunlight is reflected onto lenses beneath the trough to boil the water. The water vapour then condenses onto a cooled sloping cover above the trough and runs down this inclined surface into a collecting receptacle.

A difficulty with many desalination plants is that the remaining saline water quickly becomes saturated. This leaves a precipitated salt deposit which accumulates and interferes with operation of the desalination plant. Typically, the salt must be regularly cleaned away in order to restore the desalination plant to full efficiency, which significantly increases operating costs for the desalination plant.

As one example, it is desired to provide a desalination plant which requires minimal use of non-renewable energy sources. Also, as another example, it is desired to provide a desalination plant that is cost-effective to build, and to operate. As a further example, it is desired to provide a desalination plant that produces fresh water in suitable quantities to support a local population. As another example, it is desired to provide a desalination plant that better tolerates salt deposits.

These and/or other problems are addressed by the example embodiments of the present invention, as will be appreciated from the following description or by practising the example embodiments of the invention.

### SUMMARY OF THE INVENTION

According to the present invention there is provided an apparatus and method as set forth in the appended claims, including particularly a desalination apparatus, a module and a method of desalination. Other features of the invention will be apparent from the dependent claims, and the description which follows.

In one aspect, a desalination apparatus comprises a series of modules which may be mounted on supports. Seawater flows through base units along a channel by gravity and is heated by a heating unit such as solar lenses to produce water vapour. A chimney induces an airflow laterally across the channel and substantially perpendicularly to the water flow. The airflow draws the water vapour to a condenser that collects fresh water. The condenser may be mounted within the chimney and may use cold seawater as a coolant.

In one aspect there is provided a desalination apparatus comprising a water container arranged to hold saline water in use, a heating source arranged to heat the saline water, a chimney arranged to induce an airflow over the water unit to collect water vapour, and a condenser arranged to condense fresh water from the water vapour. The apparatus is characterised in that a channel is arranged to contain a flow of saline water in use, wherein the channel comprises an inlet end and an outlet end and the water flows along the channel by gravity, a heating unit is arranged to heat an interior of the channel in order to heat the saline water to produce a water vapour, a chimney is arranged to induce an airflow laterally across the channel to draw the water vapour away from the channel, and a condenser arranged to condense fresh water from the water vapour.

In one aspect, there is provided a desalination unit for use in a desalination plant. The desalination unit may comprise a channel arranged to contain a flow of saline water in use; a heating unit arranged to heat an interior of the channel in order to heat the saline water to produce a water vapour; a chimney arranged to induce an airflow across the channel to draw the water vapour away from the channel; and a condenser arranged to condense fresh water from the water vapour.

The channel is suitably elongate from an inlet end to an outlet end. The desalination unit allows a substantially continuous flow of saline water along the channel, while heating an upper surface of the water. The water flows dynamically along the channel. Water vapour from the channel is transported laterally toward the condenser. The desalination unit may have one side facing the sun to capture solar energy which heats the water and which induces the airflow. A shaded side of the desalination unit carries the condenser, and may also carry a supply of coolant to the condenser.

In one example, the desalination unit is divided into a plurality of modules which are coupled together in series. Each of the modules may further comprise a sealing arrangement to seal that module in use against an adjacent module. The modules are mounted on supports, such that each module has a gradual downward incline to induce a flow by gravity along the channel. Each of the modules comprises a base unit that forms the channel. In one example, the base unit further forms an evaporation chamber to contain the water vapour above the channel until the water vapour is drawn out of the evaporation chamber by the chimney.

In one example, the saline water flows longitudinally along the channel and the chimney is arranged to induce an airflow substantially perpendicularly to the water flow direction, such that air is drawn laterally over the channel and upwardly into the chimney to carry the water vapour to the condenser.

Suitably, a throat plate is arranged along the channel as a non-return valve which inhibits the water vapour from returning into the evaporation chamber. The condensed water from the condenser suitably falls by gravity and is collected. Conveniently, the water is collected in the throat plate arranged below the chimney. In one example, the throat plate extends continuously alongside the channel and is coupled to a fresh water outlet to provide the fresh water from one end of the desalination unit.

In one example, the chimney comprises a reheat portion that draws the airflow up the chimney by solar energy.

In one example, a preheat portion is mounted at one side of the channel that draws ambient air toward the channel and heats the ambient air by solar energy.

Conveniently, the condenser is mounted within the chimney. In one example, the condenser comprises a condenser dribble pipe which is coupled to receive a coolant, and wherein the coolant flows though the dribble pipe under gravity. A coolant delivery pipe is arranged along a rearward surface of the chimney that is shaded in use, to carry the coolant to the condenser unit.

In one example, the desalination unit is coupled to a solar gain battery unit which preheats the saline water before introducing the heated saline water into the channel. The desalination plant may include two or more of the desalination units which may be arranged in parallel. In one example, a coastal desalination plant draws seawater, some of which is heated as the saline water and some of which acts as the coolant in the condenser.

In another aspect there is provided a module for use in a desalination unit, the module comprising a base unit that forms a channel to carry a flow of saline water and an evaporation chamber to contain water vapour above the channel; a heating unit comprising an array of lenses arranged to heat an upper surface of the saline water by solar energy; a chimney arranged to induce an airflow through the evaporation chamber across the channel to carry the water vapour away from the channel; and a condenser to condense the water vapour and provide fresh water. The module may include a sealing arrangement to seal that module against an adjacent module.

In one aspect there is provided a method of desalinating a source of saline water, the method comprising flowing the saline water along a channel by gravity; heating the water in the channel to provide a water vapour; inducing an airflow laterally across the channel with a chimney by solar energy to carry the water vapour away from the channel to a condenser; condensing the water vapour using the condenser to provide a condensate; and collecting the condensate as fresh water.

The desalination unit may be operated for several hours each day, during a peak period of solar energy. Then the desalination unit is automatically cleaned by running the saline water through the channel in an off-peak period. That is, as the sun wanes the saline water is evaporated less efficiently and instead cleans any salt deposits in the channel.

### BRIEF DESCRIPTION OF THE DRAWINGS

For a better understanding of the invention, and to show how example embodiments may be carried into effect, reference will now be made to the accompanying drawings in which:

FIG. 1 is a schematic elevation view of an example desalination plant;

FIG. 2 is a schematic plan view of an example desalination plant;

FIG. 3 is a perspective view of a first example desalination unit;

FIG. 4 is a sectional side view of the first example desalination unit;

FIG. 5 is a perspective view of a second example desalination unit;

FIG. 6 is a sectional side view of the second example desalination unit;

FIG. 7 is a sectional side view of a portion of the desalination unit; and

FIG. 8 is a perspective view of a solar gain battery unit.

### DETAILED DESCRIPTION OF THE EXAMPLE EMBODIMENTS

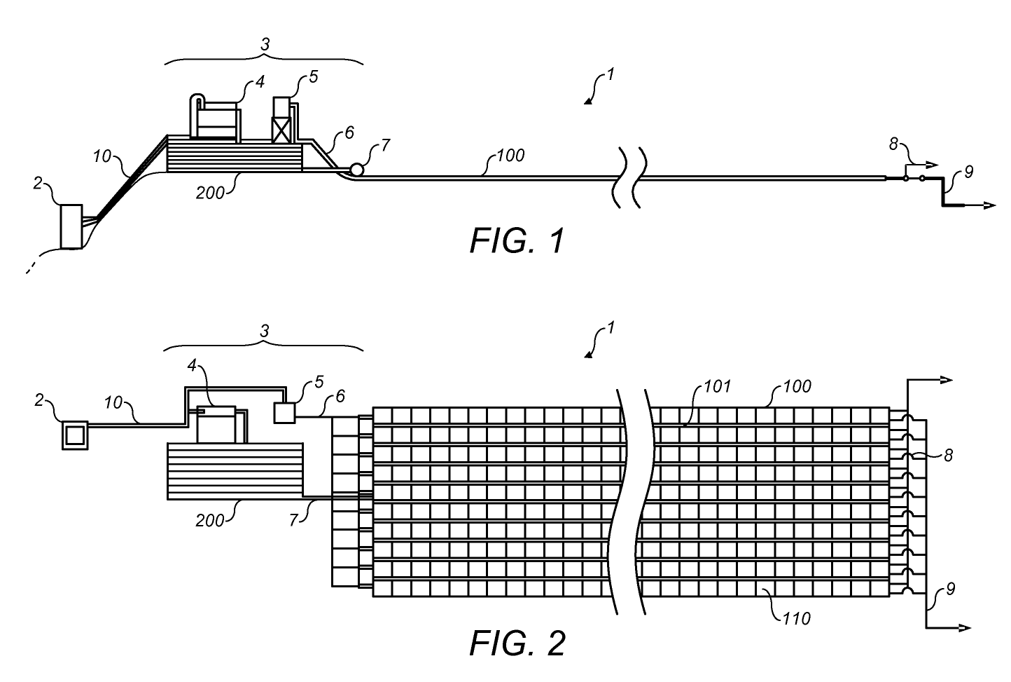

FIG. 1 shows an example desalination plant in elevation and FIG. 2 shows the desalination plant in plan view. The desalination plant is suitably installed at a coastal site, close to a ready supply of seawater. The desalination plant 1 suitably includes an intake pipe 10, a pumping station 2, and a holding area 3, which supply seawater to a desalination apparatus. In this example, the desalination apparatus includes one or more desalination units 100.

In use, the pumping station 2 pumps seawater along the seawater intake pipe 10 into the holding area 3, which may include a hot water header tank 4 and a cold water header tank 5. The cold water header tank 5 feeds the cold seawater into a cold water distribution manifold 6. Meanwhile, the hot water header tank 4 feeds the seawater into one or more battery units 200 which suitably heat the seawater, such as by solar gain. The hot seawater is then supplied into a hot water distribution manifold 7.

In this example, the one or more desalination units 100 are arranged to receive the hot seawater from the hot water manifold 7. Also, the desalination units 100 are arranged to receive the cold seawater from the cold water manifold 6. Each desalination unit 100 is arranged to provide fresh water from the hot seawater, suitably by using solar energy to heat the hot seawater into a water vapour, and then using the cold seawater as a coolant to condense fresh water from the water vapour.

Each of the desalination units 100 forms an elongate trough or channel from an inlet end to an outlet end. Each of the desalination units 100 is suitably of the order of 300 m (1000 ft) in length. The hot seawater flows continuously along the channel and is heated by a suitable heat source to produce the water vapour. This vapour passes into a condenser arrangement running alongside the channel, where fresh water condenses and is collected into a fresh water collection channel. At a downstream end, the desalination units 100 are coupled to a fresh water output manifold 8 which outputs a fresh water supply, and to a brine manifold 9 which outputs a remainder of the seawater.

In this example, as shown particularly in FIG. 2, a plurality of the desalination units 100 are arranged in parallel with an access path 101 therebetween for initial installation, and later maintenance, by a suitably equipped vehicle and crew. However, the example desalination units 100 require minimal maintenance and are largely self-cleaning.

The example desalination units 100 employ solar energy and thus are arranged to maximise solar gain. The desalination units 100 are conveniently arranged with a sunward side and a shaded side. In the northern hemisphere, the desalination units 100 are arranged with their longitudinal axis generally east-west, giving a sunward edge to the south and a shaded edge to the north.

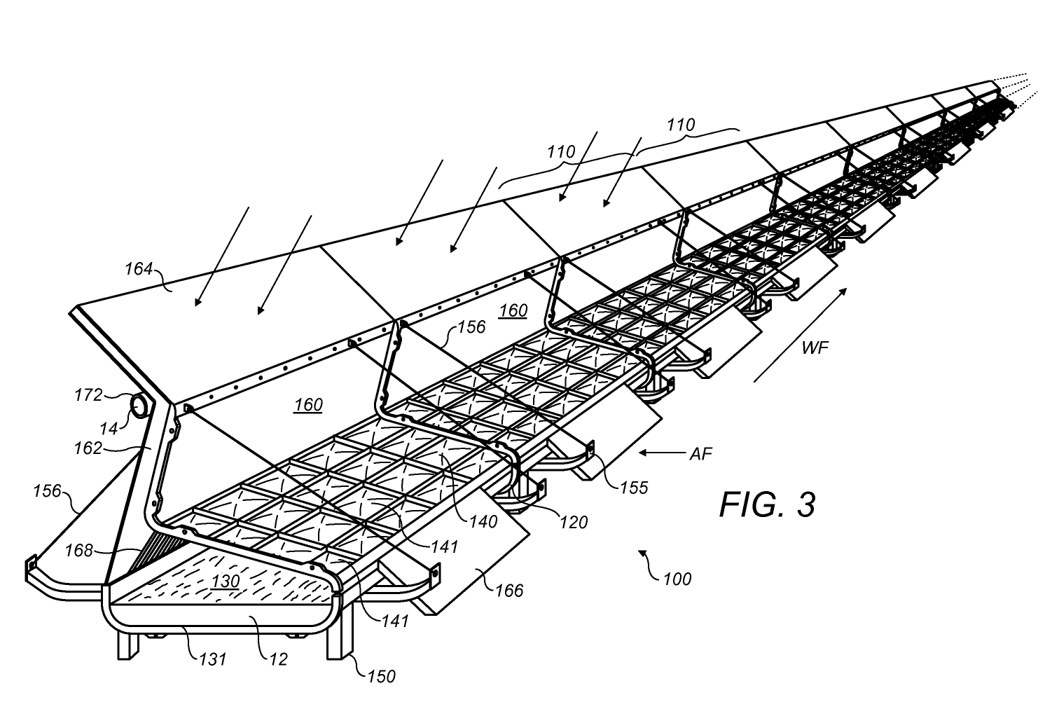

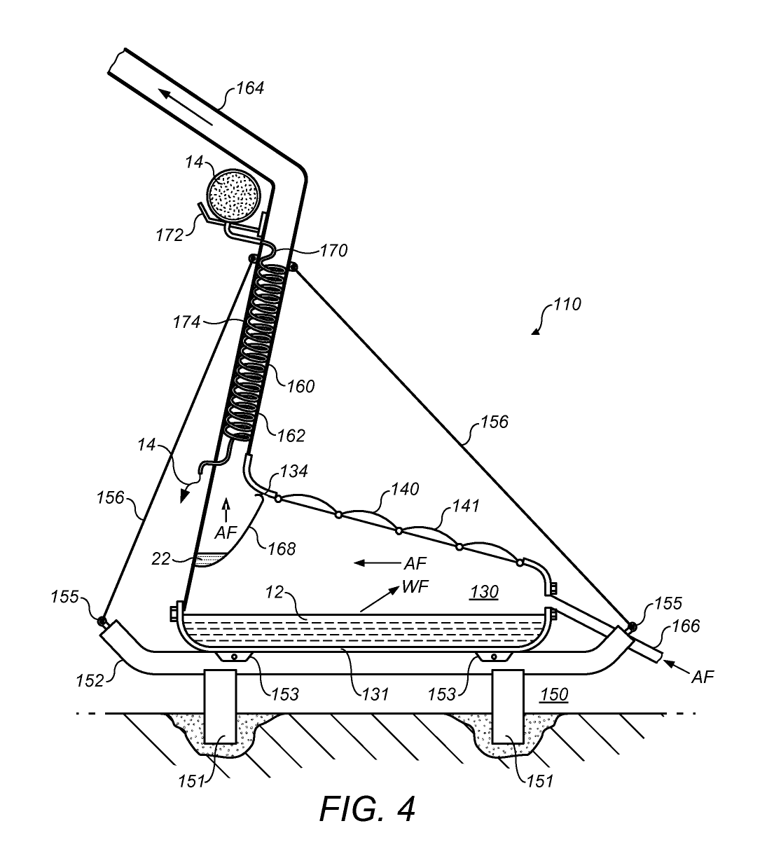

FIG. 3 is a perspective view of one of the desalination units 100, including a partial sectional view so that an interior of the desalination unit 100 can be seen in greater detail. FIG. 4 is a sectional side view of one of the modules 110 also showing the interior of the desalination unit.

As shown in FIG. 3, the desalination unit 100 suitably comprises a plurality of modules 110 which in use are coupled together to form a continuous flow line. Each of the modules 110 may comprise a sealing arrangement 120, a base unit 130, a heating unit 140, a support unit 150 and a chimney unit 160. Further, a condenser 170 is provided, as shown in FIG. 4.

Conveniently, each of the modules 110 is fabricated separately in advance. The modules 110 are then transported to a suitable site and assembled together. Here, the sealing arrangement 120 is provided to seal each module 110 against an adjacent module. As one example, the sealing arrangement 120 comprises a silicone rubber gasket which seals the module 110 against an adjacent module. The gasket 120 conveniently provides an expansion joint to allow for thermal expansion of each module 110.

The base unit 130 forms a trough or channel 131 to carry the hot saline water 12. The base unit 130 may be manufactured from fibre reinforced cement composite, suitably with stiffening ribs on an outside surface thereof, such as in a waffle box pattern. It has been found that fibre reinforced cement composite is light and strong, and has good heat insulation properties. The composite is tough and durable, and has some inherent flexibility. Typically, such a composite is currently used as a roofing product. Advantageously, the composite has a relatively low manufacturing cost.

In this example, the heating unit 140 provided in the modules 110 exploits solar energy. That is, the heating unit 140 suitably comprises an array of lenses 141, such as Fresnel lenses, which focus solar rays into the trough 131 in order to heat an interior of the base unit 130. These lenses 141 face the sunward side of the desalination unit 100 and focus solar energy onto an upper surface of the seawater 12. Other example embodiments may use other forms of heating, such as a gas fired or oil fired heat source running below the trough 131 of the base unit 130. However, a solar energy source is preferred. Also, multiple heat sources may be combined in the same unit. Suitably, the base unit 130 forms an evaporation chamber where the water vapour from the channel 131 is contained.

In use, the hot sea water 12 lies in the base unit 130 and flows along the channel 131 formed by the line of modules 110 in series. Conveniently, the sea water 12 flows continuously along the line of modules 110 by gravity. Here, the modules 110 are mounted on supports 150, such that each module 110 has a gradual downward incline in the water flow direction shown by the arrow WF. In one example, the modules 110 are inclined with a fall of about 1:500 per unit length. The modules 110 may be located to the supports 150 by an adjustable levelling mechanism, such as removable shims, to achieve the desired inclination.

The supports 150 optionally provide anchor points 155 for tie bars 156 which support the chimney unit 160. The example desalination plant 1 is intended for installation in a costal area, where costal breezes are likely to impinge on the desalination units 100 with a significant load. Hence, the ties 156 help to provide sufficient structural rigidity. However, these coastal breezes are also helpful in driving airflow through the desalination units 100.

As shown more particularly in FIG. 4, each of the supports 150 may comprise a pair of leg members 151 joined by substantially horizontal crossbars 152 to form an inverted U-shape. The supports 150 are spaced apart along the length of each line of modules 110, conveniently with two supports 150 for each module 110, so that each module 110 is independently supported. The post 151 are conveniently anchored firmly into a ground surface and the horizontal crossbar 152 placed on top and levelled using the levelling mechanism. The remainder of the module 110 is then lowered into position. Thus, each module 110 is readily assembled and installed on site, and the line 100 is rapidly created. Locators 153 may be provided on the supports 150 and/or on the base unit 130 to assist location of the base unit 130 with respect to the support 150.

Notably, the support structure 150 can be installed and arranged in advance, including levelling the crossbars 152 to provide the desired fall rate or incline, and then the modules 110 can be craned into position to complete the flow line.

Looking again at FIGS. 3 and 4, in use the hot sea water 12 flows longitudinally along the desalination unit 100 as indicated by the flow direction WF. Meanwhile, the airflow is induced through each module 110 in an airflow direction AF, which is suitably generally perpendicular to the water flow direction WF. Thus, the air flow is induced laterally across the distillation line 100. Suitably, the air flows transversely across the water flow. In use, the air is drawn through the base unit 130 and upwardly into the chimney 160, to carry water vapour into the chimney. The condenser 170 mounted within the chimney 160 then condenses the fresh water, as will be explained further below.

Suitably, the ambient air is already relatively hot and relatively dry (i.e. has a low humidity), as would be found, for example, in equatorial desert conditions. Optionally, a preheat portion 166 may be provided. In this example, the preheat portion 166 provides a chamber that draws ambient air into the base unit 130. Conveniently, the preheat chamber 166 further heats the ambient air. The preheat chamber 166 is mounted at one side of the base unit 130 and uses solar energy to heat the air passing through the chamber. The preheat chamber 166 suitably has a black, solar-absorbent surface and is angled to capture solar energy. The hot air in the preheat chamber 166 then rises through the chamber 166 and into the base unit 130.

In use, the heating unit 140 heats the sea water 12 to produce a mass of water vapour within the base unit 130. That is, the air in the base unit 130 increases in humidity as the air flows over the heated water. This water vapour is then drawn upwardly through the chimney 160.

The chimney 160 conveniently comprises a condenser portion 162 and a reheat portion 164. The reheat chimney 164 suitably absorbs solar energy and becomes heated, which draws the airflow through the base unit 130 and up the chimney 160 with a powerful updraft. The moisture vapour from the base unit 130 is drawn over a throat plate 168 though a narrow aperture 134 to reach the condenser 170 in the condenser portion 162. A coolant supply system 172 supplies a coolant 14 to the condenser 170. The throat plate 168 acts as a non-return valve which inhibits the water vapour from returning into the base unit 130. Thus, the base unit 130 forms a main evaporation chamber, and a naturally induced airflow removes water vapour from the evaporation chamber toward the condenser 170.

In this example, the condensed water from the condenser 170 falls by gravity down the chimney 160 and collects in the throat plate 168 which runs along a rear wall of the base unit 130. The throat plate 168 forms a trough or drain that carries the fresh water along the shaded side of the line of modules 110, until the collected fresh water 22 is output as the fresh water supply. In one example, a single freshwater drain may be provided that runs between two of the lines 100, so that fresh water from both lines feeds into this common drain.

Advantageously, the sea water 12 flowing through the modules 110 becomes progressively more saline until, at the end of the desalination line 100, a relatively saturated brine is carried in the base units 130. Here, the brine is suitably fed to salt pans, where the salt is recovered as a convenient by-product of the desalination plant.

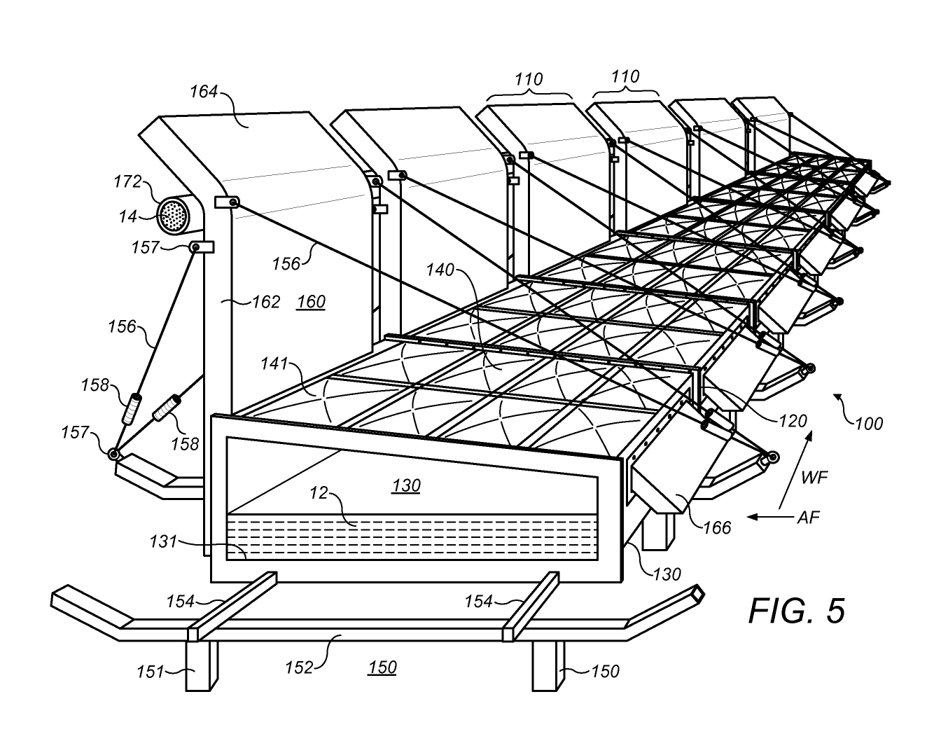

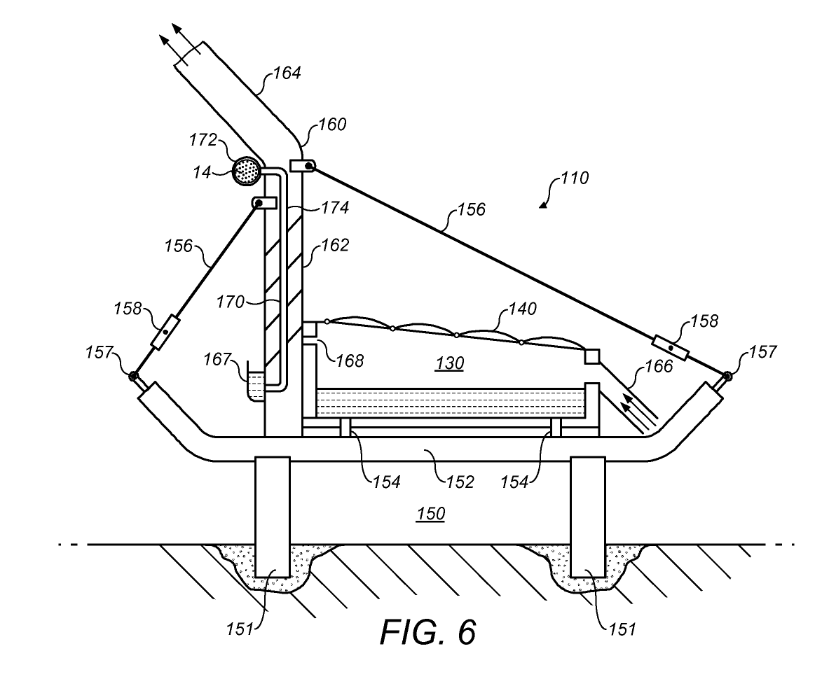

FIG. 5 is a perspective view of a second example embodiment of the desalination units 100, including a partial sectional view so that an interior of the desalination unit 100 can be seen in greater detail. FIG. 6 is a sectional side view of one of the modules 110 in this second example embodiment, also showing the interior of the desalination unit.

As shown in FIG. 5, each desalination unit 100 suitably comprises a plurality of the modules 110 coupled together to form a continuous flow line. As described above, each of the modules 110 may comprise a sealing arrangement 120, a base unit 130, a heating unit 140, a support unit 150 and a chimney unit 160. FIG. 6 further shows a condenser 170 as described before. Components that have already been described above have been identified with the same reference numerals for clarity.

The base unit 130 forms a channel 131 to carry the hot saline water 12. In this example, the base unit 130 is formed from a sandwich construction, suitable of metal sheets, such as stainless steel, with an insulating core, such as polyurethane foam filler.

In this example, each of the supports 150 has leg members 151 such as steel reinforced concrete pylons with steel crossbars 152. Each module 100 is supported by longitudinal rails 154. In this example, the wind braces 156 are suitably metal wires fastened such as to eye bolts 157. The wind braces 156 may have a tensioning mechanism 158, such as turn buckles.

The chimney 160 conveniently comprises a condenser portion 162 and a reheat portion 164. The chimney 160 is suitably fabricated from stainless steel sheets. This example also shows a coolant gutter 167 to drain the spent coolant 14 that has passed through the condenser 170.

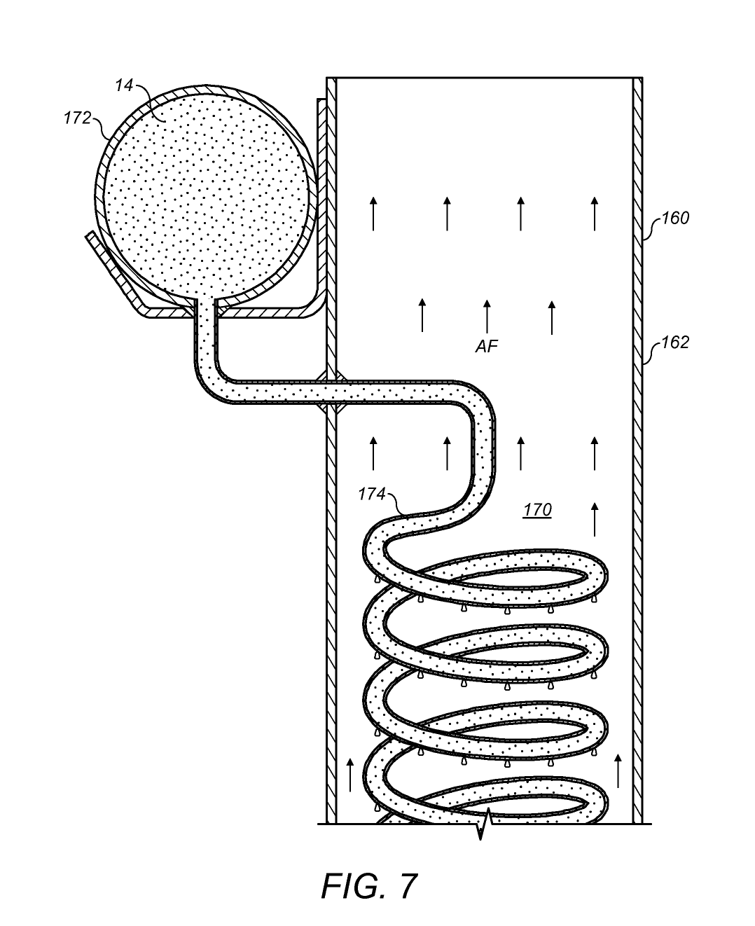

FIG. 7 is a sectional side view showing one example embodiment of the condenser unit 170 in more detail. The condenser unit 170 is coupled to a source of coolant 14 along a coolant delivery mechanism, which in this case is a pipe 172 arranged along a rearward surface of the chimney 160 so as to be shaded in use. The coolant 14 is conveniently cold sea water, which may be supplied from the cold water manifold 6 of FIG. 1. The coolant 14 delivered by the coolant supply pipe 172 flows through a condenser dribble pipe 174, which here is suitably formed from stainless steel. In this example, the coolant 14 dribbles under gravity down through a descending pipe network 174, in this example in a spiral pattern. The spent coolant 14 then is ejected and flows away. For example, the spent coolant 14 is directed into a gutter (not shown) running alongside the line 100.

In one example, the hot sea water 12 is provided into the desalination unit 100 at a rate of about 1.2 m³ per minute. The hot sea water 12 flows along the base units 130 at a rate of approximately 3 m per minute. In one example, the line is about 300 m in length, so that the hot sea water 12 is subject to heating from the solar concentrator lenses 141 for approximately 100 minutes as the sea water 12 flows down the channel 131. In one example, the fresh water 20 is provided at a rate of about 1 m³ per minute.

In one example, the chilled water for the condenser 170 (which is required in a relatively small volume) is taken from about 30 metres deep in the ocean where it is typically provided at less than 10 C, even at warmer latitudes. The seawater for desalination (which is required in a relatively larger volume) is taken from close to the surface where it is typically 30 C or more. However, it is helpful to further heat the warm seawater before delivery to the units 100.

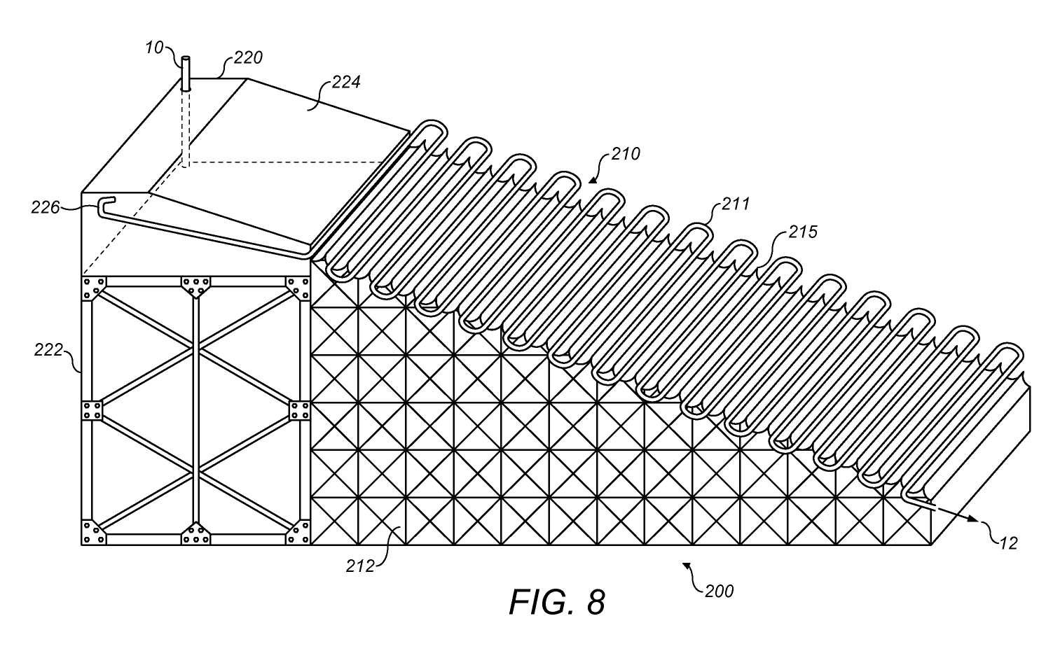

FIG. 8 is a perspective view of one example embodiment of a solar gain battery unit 200, which may comprise a pipe network 210 and a header tank 220. In one example, the header tank 220 is approximately 9 m wide, 30 m long and 3 ml deep. The header tank 220 is mounted on a tank support structure 222 that elevates the tank 200 to about 20 m above the level of the distillation line 100.

In one example, the pipe network 210 comprises black steel pipes of 400 mm diameter. The pipes are mounted adjacent an array of reflectors 215, which are suitably parabolic reflectors that focus solar energy onto the pipes 210. The pipes 210 and the reflectors 215 are suitably supported by a framework 212. Conveniently, the pipe network 210 is approximately 27 m wide with an expansion of joints 211 provided at the end of each pipe length. The pipe network conveniently comprises 30 lengths with a throughput of approximately 2.4 m³ per minute, which is sufficient for two of the desalination lines 100. The sea water dwells in the solar heated pipe network 210 for approximately 30 minutes such that the heated sea water 12 output by the solar gain battery unit 200 is at or about 100° C. and thus already close to boiling point before reaching the desalination line 100.

In one example, two of the distillation lines 100 are provided together as a pair, which forms a basic unit of the desalination plant. Conveniently, each pair of lines has an associated hot water header tank 4 and solar gain battery 200. This design improves reliability. If one seawater supply pump breaks down or requires maintenance, then the remaining lines continue to function. It is to be expected that the seawater pumps will inevitably require maintenance which will be programmed for winter night time but these often require more time and this flexibility will be of great value.

In another example, the header tank 220 is about 90 m long, 10 m wide and 3 m deep and is provided about 6m above the desalination lines 100. Also, the solar gain battery 200 may comprise ten pipes of 90 m length. This configuration allows the header tank 220 and the solar gain battery 200 to align conveniently with the desalination lines 100 each of about 10 m wide with an access road of about 10 m wide between each pair of lines.

Sea water which ideally has been extracted from a relatively warm surface level of the sea is pumped into the header tank 220 and dwells for about five hours in the tank. The pipe network 210 has a fall of about 18 m at an angle of about 20° to provide the desired flow rate and solar capture. The tank 220 has an upper cover portion 224 that faces sunward and is conveniently sloped to maximise solar gain and provide an initial warming of the sea water. The water exits the header tank at approximately 50-60° C. The warmed sea water exits the header tank 220 via an overflow 226 into the pipe network 210.

Conveniently, the sea water flows by gravity through the solar gain battery unit 200, and then flows again by gravity thorough the desalination line 100. Thus, having invested energy initially to raise the sea water 10 into the header tanks, the remainder of the system runs under gravity and does not require further pumping.

Notably, the desalination line 100 is readily adapted according to local conditions of each installation by adding or removing the modules 110 according to the conditions on this site. Advantageously, the described desalination unit has a relatively low capital cost. Further, the desalination unit 100 has minimal operating costs. Also, the mass-produced modular nature of the desalination unit 100 allows significant manufacturing cost savings to be achieved.

In the example embodiments, a large volume of hot dry desert air is drawn across the hot water stream to evaporate fresh water vapour from the preheated seawater. In one example, airflow of 50 cubic metres per second along the total length of the units with a cross draught speed of one metre per second is equivalent to 1.8 million cubic metres per 10 hour day for each 300 metre line.

In one example, the preheat chimneys draw hot desert air from close to the surface of the hot desert floor which is often more than 70 degrees Celsius in full sun. In solar gain terms the area of the desert floor stretches for hundreds of miles and is in practical terms infinite such that it provides desalination units with an unlimited supply of this hot dry air.

The industrial application and advantages of the present invention are readily appreciated from the discussed herein. The example desalination plant produces fresh water in abundant quantities to support a local population for consumption, agriculture and industry. The example desalination apparatus requires minimal use of non-renewable energy sources.

The example desalination plant is cost-effective to build, particularly by using separate modules in series. Also, the example desalination plant is cost-effective to operate, and tolerates or avoids salt deposits.

Although one or more example embodiments have been shown and described, it will be appreciated by those skilled in the art that changes and modifications can be made without departing from the scope of the invention, as defined in the appended claims.

1. A desalination apparatus, comprising:
a channel arranged to contain a flow of saline water in use, wherein the channel comprises an inlet end and an outlet end and the water flows along the channel by gravity;
a heating unit arranged to heat an interior of the channel in order to heat the saline water to produce a water vapour vapor;
a chimney arranged to induce an airflow laterally across the channel to draw the water vapor away from the channel; and
a condenser arranged to condense fresh water from the water vapour vapor.

2. The desalination apparatus of claim 1, wherein the apparatus comprises a plurality of modules which are coupled together in series.

3. The desalination apparatus of claim 2, wherein each of the modules further comprises a sealing arrangement arranged to seal the module in use against an adjacent one of the modules.

4. The desalination apparatus of claim 2, further comprising a plurality of supports, wherein the modules are mounted on the supports in use such that each module has an incline to induce the water flow by gravity along the channel.

5. The desalination apparatus of claim 2, wherein each of the modules comprises a base unit that forms the channel and wherein the base unit further forms an evaporation chamber to contain the water vapor above the channel until the water vapor is drawn out of the evaporation chamber by the chimney.

6. The desalination apparatus of claim 1, wherein the channel is arranged to carry the saline water longitudinally along the channel and the chimney is arranged to induce an airflow laterally substantially perpendicular to the water flow direction, such that air is drawn over the channel and upwardly into the chimney to carry the water vapour vapor to the condenser.

7. The desalination apparatus of claim 6, further comprising a throat plate arranged along the channel as a non-return valve which inhibits the water vapor from returning into the evaporation chamber, and wherein the condenser is arranged so that the condensed water from the condenser falls by gravity down the chimney and collects in the throat plate.

8. The desalination apparatus of claim 1, wherein the chimney further comprises a reheat portion that draws the airflow up the chimney by solar energy.

9. The desalination apparatus of claim 1, further comprising a preheat portion mounted at one side of the channel that draws ambient air toward the channel and heats the ambient air by solar energy.

10. The desalination apparatus of claim 1, wherein the condenser is mounted within the chimney.

11. The desalination apparatus of claim 1, further comprising a coolant delivery pipe arranged along a rearward surface of the chimney that is shaded in use, to carry the coolant to the condenser unit.

12. The desalination apparatus of claim 1, wherein the heating unit comprises a plurality of lenses arranged above the channel to heat an upper surface of the saline water by solar energy.

13. A module for use in a desalination apparatus, the module by comprising:
a base unit comprising a channel to carry a flow of saline water and an evaporation chamber to contain water vapour vapor above the channel;
a heating unit comprising an array of lenses arranged to heat an upper surface of the saline water by solar energy;
a chimney arranged to induce an airflow through the evaporation chamber laterally across the channel to carry the water vapor away from the channel; and
a condenser to condense the water vapor and provide fresh water.

14. The module of claim 13, wherein the module is arranged to be coupled in use to a plurality of other modules in series, and the module further comprises a sealing arrangement arranged to seal the module in use against an adjacent one of the plurality of modules.

15. A method of desalinating a source of saline water, the method comprising:
flowing the saline water along a channel by gravity;
heating the water in the channel to provide a water vapor;
inducing an airflow laterally across the channel with a chimney by solar energy to carry the water vapor away from the channel to a condenser;
condensing the water vapor using the condenser to provide a condensate; and
collecting the condensate as fresh water.
